(19) United States
(12) Patent Application Publication
(10) Pub. No.: US 2012/0242331 A1
(43) Pub. Date: Sep. 27, 2012

(54) HALL-BASED ROTATIONAL ANGLE MEASURING SYSTEM, IN PARTICULAR FOR HAND-OPERATED THROTTLES

(76) Inventors: Werner Dengler, Geretsberg (AT); Bastien Walser, Feldkirch (AT)

(21) Appl. No.: 13/508,504

(22) PCT Filed: Dec. 2, 2010
(86) PCT No.: PCT/EP2010/007321

§ 371 Date: Jun. 19, 2012

(30) Foreign Application Priority Data
Dec. 4, 2009 (DE) 10 2009 056 732.1

(51) Int. Cl. G01B 7/30

(52) U.S. Cl. 324/207.25

(57) ABSTRACT

The invention relates to a sensor assembly (1), wherein according to the invention the magnet (3) is subdivided into at least three magnetic segments, wherein each magnetic segment has an individual north and south pole (N, S) and the sensor (4) is arranged outside the magnet (3) and, when the magnet (3) is moved, is in each case arranged directly opposite the magnetic pole of the respective magnetic segment and is located in the main flux direction of the magnetic field lines.

The invention relates to a sensor assembly for measuring the movement of an element, in particular for measuring the rotation of a shaft, and having a magnet that can be moved by the element and a sensor for measuring the movement of the magnet.

Contact-free sensors, in particular angular-movement detectors, based on inductive, capacitive, resistive and Hall-based systems have already been disclosed in the prior art, in particular for hand-operated throttles of vehicles but also for measuring translatory movements. Hall rotational angle systems are divided into tube-shaft systems and systems that have to be mounted at the end (stub) of the shaft.

The object of the invention is to develop a contact-free sensor assembly that drastically reduces the disadvantages of previous systems with regard to external field effects and that significantly increases resolution.

This object is achieved either by the characteristics of independent patent claim 1 or 2, or, in a particularly preferred manner, by the combination of the characteristics of these patent claims 1 and 2, reproduced in patent claim 3.

On the one hand, according to the invention, the magnet is subdivided into at least three magnetic segments each having its own north and south pole. Unlike normal two-pole magnets that only have a single north and south pole, with the sensor assembly according to the invention, at least three segments, i.e. at least three poles of the magnet, are used to measure the position of the movable element. As a result, an angular movement of only 90°, for example, advantageously enables the field lines of the magnet to describe an angular change of up to 360°, which can be measured by the sensor assembly and subsequently evaluated. The decisive advantage here is that the raw or useful signal itself can be resolved with appropriate accuracy for generating the useful data. This is because previously known commercially available systems are only able to use a resolution of 12 bits for a 90° change in the magnet angle, which leads to multiple quantification errors in the subsequent linearizations, scalings and data conversions of the raw signal, likewise with a resolution of 12 bits. In contrast to this, the magnetic contingent absorbed perpendicular to the direction of movement (translatory or rotational), i.e. the field lines in the X and Z-direction, can be used as an absolute value to calculate the actual position. Put simply, the position of the magnet can be deduced from the function arctan(Bx/Bz). At the same time, further correction factors can be used for linearization. The sensor assembly (measuring system) according to the invention is tolerant to temperature and age-related drift of the magnet because of the preferentially used differential measuring method.

As an alternative or in addition thereto, according to the invention, the sensor assembly is mounted outside the magnet and, when the magnet is moved, is always directly opposite the magnetic poles of the respective magnet segment and is located in the main flux direction of the magnetic field lines. In a sensor assembly for measuring angular movements of an element, the sensor, i.e. the magnetically sensitive element (preferably a Hall sensor), is closely radially juxtaposed with the outer surface and is therefore directly opposite the magnetic poles of the magnet. The magnetization direction of the magnet and the sensor results in a significantly increased signal-to-noise ratio compared with known arrangements, as in the existing known systems the sensors are located in the bypass flux (bypass flux direction) of the magnetic field lines. These are therefore considerably more sensitive to external fields. That is to say, external effects can be considerably reduced with this arrangement of the sensor in the main flux direction of the magnetic field lines.

External influences can be significantly reduced and the resolution significantly increased in a particularly advantageous manner when the characteristics of patent claims 1 and 2 are combined with one another in accordance with patent claim 3.

The present explanation of the two alternatives of the invention or their particularly preferred combination applies to sensors that execute either translatory movements (to-and-fro movement) or angular movements. In the structural embodiment of such a sensor assembly, the magnet can be produced as a separate component and subsequently fixed to the rotationally moving or sliding element. As an alternative thereto, it is conceivable that the magnet is integrated into or on the movable element when it is manufactured and is therefore a constituent part of the movable element. Likewise, in a particularly preferred manner, the sensor assembly for measuring angular movements is placed in a tube-shaft assembly, where however, as well as this, systems can also be used with the sensor assembly mounted on the shaft stub.

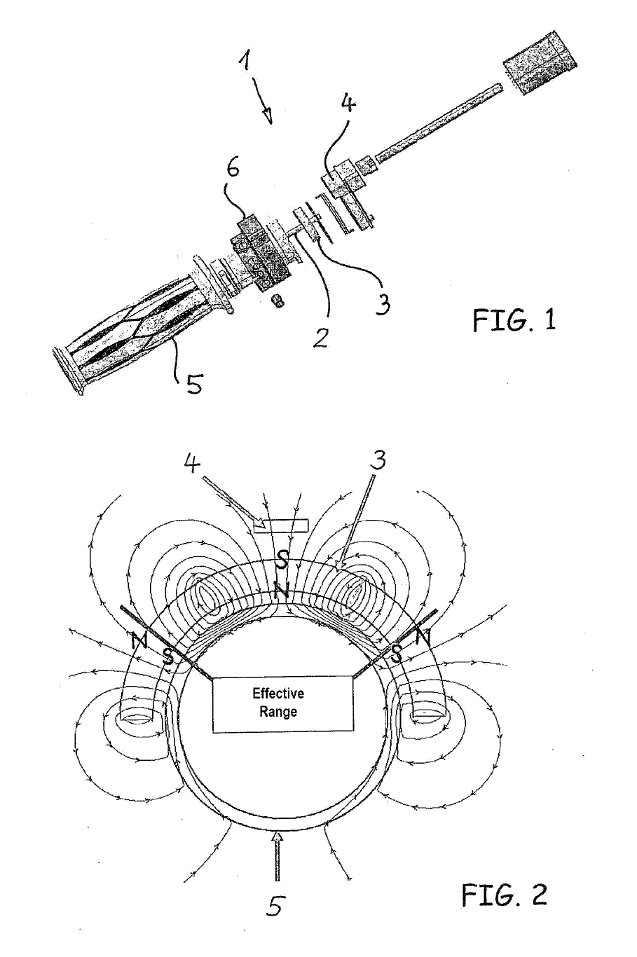

A particularly preferred illustrated embodiment, to which the invention is not restricted however, is explained below and shown in FIGS. 1 and 2.

Where shown in detail, FIG. 1 shows a sensor assembly 1 that is used in a tube-shaft assembly. The sensor or the tube-shaft assembly shown has a shaft 2 whose rotation direction (angular movement) is to be measured by the sensor assembly 1. A magnet 3 is mounted on the shaft 2 for this purpose. A possible arrangement of the magnet 3 is shown in FIG. 2. Furthermore, the sensor assembly 1 has a sensor 4, i.e. a magneto-sensitive element such as a Hall sensor for example (if redundancy is required, two or possibly even more than two sensors can also be used).

The angular movement of a hand-operated throttle 5 of a vehicle, such as a motorcycle for example, is measured with the sensor assembly shown in FIG. 1. Furthermore, the sensor assembly 1 has a plug-in device by means of which the raw signals of the sensor 4 are outputted in a suitable form to a downstream evaluation or control device (for example an electronic fuel supply in the case of a hand-operated throttle). In addition, the system shown in FIG. 1 is designed so that the hand-operated throttle is rotatable by an operator between two stops, one of the stops defining the starting position away from which the hand-operated throttle 5 can be rotated by the operator. This angular movement takes place against the force of a spring, here a return spring, so that the hand-operated throttle 5 is moved back into its starting position (idling) without force being applied by the operator.

In the illustrated embodiment according to FIG. 1, the magnet 3 has a round shape and the movable element is the shaft 2 on which the magnet 3 is fixed, the sensor 4 furthermore being closely juxtaposed with the outer surface of the magnet 3. When considering FIG. 1, it must be taken into account that the sensor assembly 1 together with the hand-operated throttle 5 shown in an exploded view in order to be able to show and distinguish the individual components. After assembly, the components of the sensor assembly 1, in particular the magnet 3 and the sensor 4 (including a plug-in connector), fit in a housing 6 of the sensor assembly 1 that is located at one end of the hand-operated throttle 5.

In the embodiment according to FIG. 1, the magnet 3 is a disk having a hole through which the shaft 2 is extends so that the magnet 3 can be mounted and fixed (for example glued) on the shaft 2.

As an alternative thereto and to explain that the sensor 4 is mounted outside the magnet 3 and, when the magnet 3 is moved, is always directly opposite the magnetic poles of the respective magnet segment and is located in the main flux direction of the magnetic field lines, reference is made to FIG. 2. In FIG. 2, it can be seen that the magnet 3 has exactly three (or also more than three) magnet segments each with its own north and south pole N, S. To assist understanding of the arrangement, the hand-operated throttle 5 (handle tube) is also shown schematically and in section. As a result of the angular movement of the hand-operated throttle 5, the magnet 3 shown with its at least 3 magnet segments is moved rotationally with respect to the fixed sensor 4 so that the poles N, S of the segments of the magnet 3 can move within (and possibly beyond) the effective usable region. This angular movement is measured in an advantageous manner by the sensor 4 in such a way that, on the one hand, the magnetically sensitive element is closely juxtaposed with the outer surface and therefore lies directly opposite the magnetic poles and, on the other hand, the sensor 4 is located in the main flux direction of the magnetic field lines shown, this magnetization direction and the shown orientation of the sensor 4 resulting in a significantly increased signal-to-noise ratio compared with known systems, as in known systems the sensor is located in the bypass flux of the magnetic field lines and a sensor of this kind is therefore substantially more sensitive to interference from external fields.

The magnet 3 shown in FIG. 2 with its at least or exactly 3 magnet segments is a ring and can be in one piece in the same way as a disk-shaped magnet for measuring angular movements or an elongated magnet for measuring translatory movements, or it can be a constituent part of the movable element, or it can be made up of a plurality of individual or separately produced magnet segments. In order, for example, to make the annular magnet 3, according to FIG. 2, individual magnetic ring segments can be manufactured with one pole lying on the outer surface (for example, a ring-segment magnet with a north pole lying on the outer surface and two ring segment magnets with a south pole lying on the outer surface (or vice versa)) and fixed in a suitable manner (for example by gluing or similar). Of course, this also applies to a magnet that extends along a direction of movement (to-and-fro movement) and that can likewise be made in a suitable form from a plurality of individual magnet segments with their own poles that alternate in the direction of movement.

In the example of the embodiment of the sensor assembly 1 shown according to FIGS. 1 and 2, in particular of the annular magnet 3, the magnetic contingent absorbed perpendicular to the direction of movement (when considering FIG. 2, an angular movement about the longitudinal axis of the hand-operated throttle 5) in the one and the at least further direction (in particular the X and the Z-direction) of the magnetic field lines B (in particular Bx and Bz) can be used as an absolute value for calculating the actual position of the hand-operated throttle 5 (with respect to its starting position). This means that the position of the magnet 3 with respect to the sensor 4 can be deduced arithmetically from the function arctan(Bx/Bz).

In summary, the present invention therefore has the advantages that fewer components are required for the sensor assembly 1 and that the sensor assembly can be calibrated after its assembly. In addition, lengths for translatory movements up to 400 mm can be realized with a resolution of 0.1 mm. In addition, the ability to manufacture the system inexpensively and the long-term stability while at the same time reducing the effects of external fields and significantly increasing the resolution must be mentioned as an advantage. This also applies in a similar way to a sensor assembly 1 for measuring angular movements (in particular in accordance with the embodiment of FIGS. 1 and 2).

While the particularly preferred application of the invention has been explained in the above for hand-operated throttles of motor vehicles, this does not constitute a limitation of the invention, so that the present invention can preferably be used in the vehicle (automotive) sector, in particular in all applications in the engine field (such as, for example, throttle valves, AGR valves, exhaust valves and the like in which a flap is mounted on a shaft and is rotated), as well as for ventilation flaps, for the measurement of gear positions, applications in the axle area and in the drive train as well as in air conditioning units and ventilation systems. Sensor assemblies serving as level sensors, for example for headlamp adjustment, are also covered thereby. In addition to vehicular applications, applications in the aerospace industry are also a possibility.

Quite particularly preferably, the sensor assembly according to the invention is used for measuring angular movements in which the angle of rotation is <360 degrees. If it is sufficient to measure a angular movement>360 degrees, then angular movements<360 degrees (i.e. more than one complete revolution about its own axis) are excluded.

List of references:

1. Sensor assembly
2. Shaft
3. Magnet
4. Sensor
5. Hand-operated throttle
6. Housing

1. A sensor assembly for measuring the movement of an element and having a magnet that can be moved by the element and a sensor for measuring the movement of the magnet wherein the magnet is subdivided into at least three magnetic segments each having its own north and south pole.

2. A sensor assembly for measuring the movement of an element and having a magnet that can be moved by the element and a sensor for measuring the movement of the magnet, wherein the sensor is mounted outside the magnet and, when the magnet is moved, is always directly opposite the magnetic poles of the magnet and is located in the main flux direction of its magnetic field lines.

3. A sensor assembly wherein the magnet is subdivided into at least three magnetic segments each having its own north and south pole (N, S) and the sensor is mounted outside the magnet and, when the magnet is moved, is always directly opposite the magnetic poles of the respective magnet segment and is located in the main flux direction of the magnetic field lines.

4. The sensor assembly as claimed in claim 3, wherein the magnet has a round shape and that the movable element is a shaft, the magnet being mounted and fixed on the shaft, the sensor furthermore being mounted directly adjacent the outer surface of the magnet.

5. The sensor assembly as claimed in claim 3, wherein the magnet is a disk or a ring.

6. The sensor assembly as claimed claim 3, wherein the sensor assembly is used in a hand-operated throttle of a vehicle.
